(19) United States
(12) Patent Application Publication
(10) Pub. No.: US 2016/0104199 A1
(43) Pub. Date: Apr. 14, 2016

(54) CARD-LINKED OFFER TRAFFICKING

(71) Applicant: Edo Interactive, Inc., Nashville, TN (US)

(72) Inventor: Christopher Dominic Campbell, Chicago, IL (US)

(21) Appl. No.: 14/511,599

(22) Filed: Oct. 10, 2014

(51) Int. Cl. G06Q 30/02

(52) U.S. Cl. CPC G06Q 30/0264

(57) ABSTRACT

A system and machine-implemented method for providing flighting of card-linked offers to card holders is provided. A flighting priority for each card-linked offer deal may be determined based on flighting parameters. A flighting schedule may automatically schedule flighting of a card-linked offer deals based on the flighting priorities and using all available budget allocated to each card-linked offer deal without going over the allocated budget.

### BACKGROUND

The present disclosure generally relates to providing card-linked offer discounts or deals and, in particular, to improving the performance of card-linked offer discounts or deals through automatic flighting of each available offer based on one or more parameters.

A card-linked offer provider typically has many clients that may each have multiple deals, each of which may have different budgets, results targets and client importance, making budget management a challenge. A client may negotiate with a card-linked offer provider to have a particular discount or deal sent to a group of potential and/or current customers. The deal may be set up to be sent out multiple times or to varying listings of potential customers. A tracking continuity program may be used to analyze the effectiveness of the discount or deal campaign.

### SUMMARY

The disclosed subject matter relates to a computer implemented method for providing a card-linked offer. The method includes receiving, by one or more processors, a card-linked offer deal, wherein the card-linked offer deal specifies at least one card-linked offer to be provided to card holders associated with at least one card issuer. The method also includes determining, by one or more processors, one or more flighting parameters associated with the card-linked offer deal. The method further includes assigning, by one or more processors, a flighting priority to the card-linked offer deal based on the flighting parameters. The method also includes determining, by one or more processors, a flighting schedule of the card-linked offer deal based on the flighting priority assigned to the card-linked offer deal. The method further includes executing, by one or more processors, the flighting schedule to send the at least one card-linked offer to targeted card holders.

The disclosed subject matter further relates to a system. The system includes a server computer for determining and scheduling flighting of a card-linked offer deal. The system also includes a first database in communication with the server computer, the first database comprising user profile information of a plurality of card holders. The system further includes a second database in communication with the server computer, the second database comprising one or more flighting parameters associated with the card-linked offer deal, wherein the server computer assigns a flighting priority to the card-linked offer deal, wherein the server computer determines a flighting schedule for the card-link offer deal based on the assigned flighting priority, wherein the server computer determines a target group of the plurality of card holders, and wherein the server computer sends a communication of a card-linked offer to the target group of card holders based on the flighting schedule.

The disclosed subject matter also relates to a non-transitory machine-readable storage medium comprising machine readable instructions for causing a processor to execute a method for providing a card-linked offer. The method includes receiving, by one or more processors, a card-linked offer deal, wherein the card-linked offer deal specifies at least one card-linked offer to be provided to card holders associated with at least one card issuer. The method also includes determining, by one or more processors, one or more flighting parameters associated with the card-linked offer deal. The method further includes assigning, by one or more processors, a flighting priority to the card-linked offer deal based on the flighting parameters. The method also includes determining, by one or more processors, a flighting schedule of the card-linked offer deal based on the flighting priority assigned to the card-linked offer deal. The method further includes executing, by one or more processors, the flighting schedule to send the at least one card-linked offer to targeted card holders.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example of a card-linked offer system.

FIG. 2 illustrates another example of a card-linked offer system.

FIG. 3 illustrates an example flighting interface.

FIG. 4 illustrates an example process for providing a card-linked offer.

FIG. 5 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein. In some instances, structures and components are shown in block diagram form in order to avoid obscuring the concepts of the subject technology.

A card-linked offer is an incentive offer that is linked to the use of a financial card, such as a credit card or a debit card. A card-linked offer may be active as soon as it is flighted or sent out to consumers, meaning the offer is associated with a user's card as soon as it is sent out to that user. For example, an active offer to receive a redemption of 10% of a purchase up to $20.00 on a particular card used at a specific merchant may be sent out to a target group of consumers. Here, any of the target group of consumers that uses that particular card at the specific merchant will receive the redemption, regardless of whether that consumer was aware of the offer.

Alternatively, a card-linked offer may be passive, such that a consumer must receive an indication of the card-linked offer for the offer to become active. For example, a consumer may receive an email presenting three active card-linked offers, but the consumer is not interested in any of the three card-linked offers. However, the email may indicate that there are additional card-linked offers that may be of interest to the consumer and provide a corresponding link. Once the consumer clicks on the link and the additional offers are presented to the consumer, the additional card-linked offers become active. An active card-linked offer may be required to be accounted for in the spend budget of the card-linked offer deal. For example, if the spend budget for a particular card-linked deal is $5,000 and the card-linked offer is a $5.00 credit to the purchaser's credit card when used for a particular transaction, then up to 1,000 of these particular card-linked offers may be active in order to stay within the spend budget. On the other hand, if 1,000 passive card-linked offers are sent out, the committed budget is anywhere between $0 and $5,000, depending on how many card holders choose to click the link to the passive card-linked offer, thereby turning it into an active card-linked offer.

A card-linked offer environment includes merchants that are interested in providing incentives to current or potential customers in order to obtain new customers, increase existing customer loyalty and increase the amount customers spend on the merchant's products or services. For example, a merchant may be a local coffee shop that is interested in providing $1.00 off of any purchase of $5.00 or more made by a consumer in order to attract new customers and reward existing customers. The card-linked offer environment also includes financial institutions or card issuers that provide the financial cards to consumers, such as banks, credit unions and the like. A card-linked offer provider may act as an exchange or a middleman to facilitate matching up card issuers with merchants. Either or both the card-linked offer provider and the card issuer have a database of consumers from which a targeted group of consumers may be chosen to receive a particular offer.

The sending or providing of the card-linked offer out to the card-holders is known as flighting the card-linked offer. A particular card-linked offer may be flighted multiple times, such as once a month for six months, twice a day for one week and the like. Multiple card-linked offers from the same advertiser may need to flighted to the same or varying groups of card holders. Further, each financial institution (e.g., card issuer) may have rules that affect card-linked offers being sent to its card holders. For example, the financial institution may blacklist (e.g., prohibit) certain advertisers because they are overexposed on other forms of advertising medium, they have a name or content that is not deemed appropriate (e.g., profanity, sexually oriented), and the like. On the other hand, a financial institution may directly fund an advertisement for a specific company. In addition, grace periods may need to be factored in to scheduling a flighting of a particular card-linked offer. For example, it may be decided not to provide the same card-linked offer to any card holder in back to back flights, such as if a particular card-holder receives a specific card-linked offer one week, that same card-holder does not receive the same card-linked offer the next week, even though that card-linked offer is scheduled to be flighted every week.

As noted above, managing the flighting of a plurality of card-linked offers is complex and cumbersome, typically requiring manual decision making and scheduling for every card-linked offer that is to be sent out. For example, a card-linked offer provider may have 800 card-linked offer deals at a particular time, each card-linked offer deal having a specific set of parameters associated with it. Scheduling and flighting so many card-linked offer deals manually may be difficult and lead to errors. It is desired to provide an automated and efficient way of flighting card-linked offers to targeted card holders.

The subject technology provides for a system that uses one or more flighting parameters to automatically and efficiently schedule flighting of multiple card-linked offers to card holders of one or more financial institutions. The flighting parameters may be numerous and varied. For example, some flighting parameters may include card issuer approval, flighting provider approval, an advertiser's identity, an advertiser's industry and an advertiser's geography. For further example, some flighting parameters may include an advertiser's historical card-linked offer performance, previous card holder activity with an advertiser, a number of possible recipients, a recipient's perceived value of the card-linked offer, a predicted number of redemptions for a specified flighting period, and a remaining budget. Yet further examples of flighting parameters may include a commission for the flighting provider, a paid placement and forms of payment accepted.

In example aspects, the flighting parameters may be used to assign or associate a flighting priority to each card-linked offer to be flighted. For example, card-linked offers with a higher flighting priority may be flighted first, flighted more often, flighted at a premium time, and the like. In other example aspects, the flighting schedule may be executed across a plurality of card issuers. For example, a particular card-linked offer from a specific advertiser may be flighted or sent to card holders of several different card issuers.

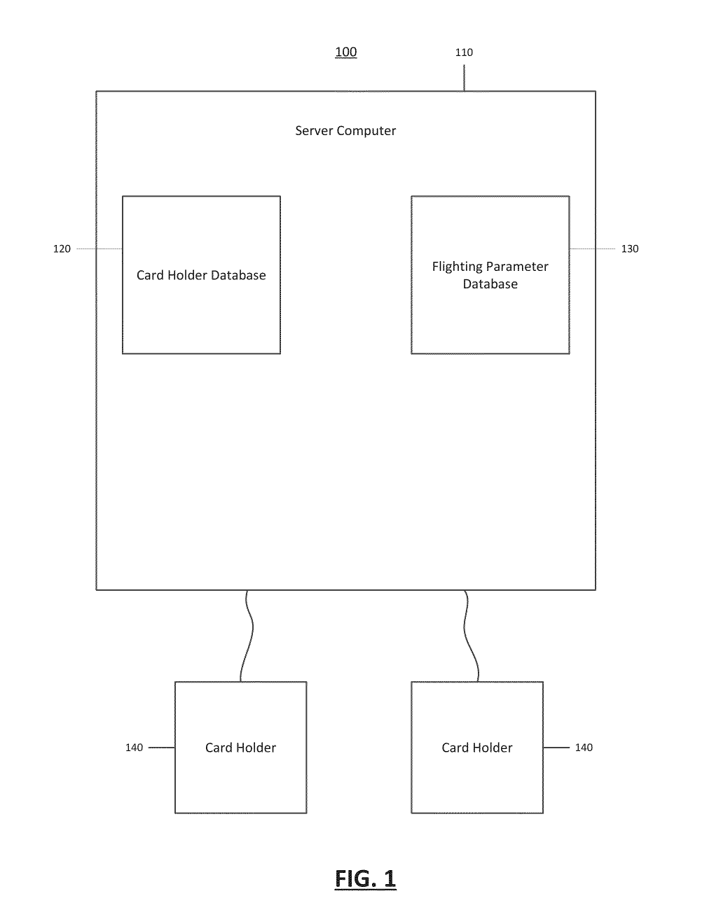

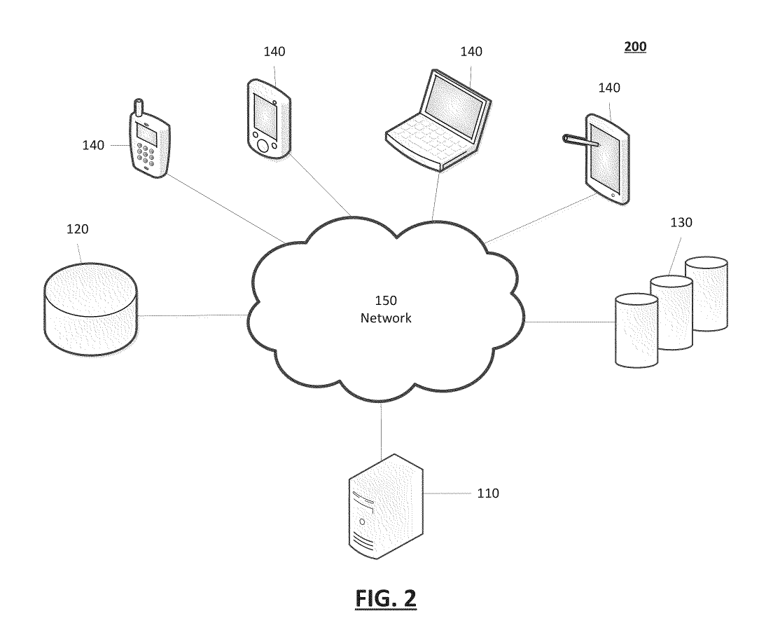

FIG. 1 illustrates an example of a card-linked offer system 100 having a server computer 110 that includes a card holder information database 120 and a flighting parameter database 130. Card holder information database 120 and flighting parameter database 130 may both be part of an integrated database or they may be separate and distinct databases on the same system or they may be separate and distinct databases on different systems as shown in FIG. 2. The server computer 110 may be in communication with multiple card holders' devices 140.

Sever computer 110 may be configured to utilize one or more flighting parameters to determine flighting priorities for multiple (e.g., a plurality) card-linked offers. For example, a flighting parameter may be the likelihood of a card-linked offer or deal resonating with a specific card holder. Here, the specific card holder may have redeemed many restaurant offers recently, so the priority of the card-linked offer may be increased (e.g., bubbled up) for that specific card holder if the card-linked offer is a restaurant offer. Server computer 110 may be further configured to utilize card holder information to determine which card holders are to receive each card-linked offer and over which card issuers each card-linked offer is to be provided. For example, a flighting provider may have contracts or negotiated arrangements with ten card issuers with each card issuer having more than one type of card that it issues to its card holders. Thus, server computer 110 may determine that a particular card-linked offer is to be flighted to only three of the ten card issuers and to only the highest level card (e.g., black or platinum) for each of the three card issuers. Further, server computer 110 may determine that the card-linked offer is to be sent only to the card holders having these high level cards of the three identified card issuers within a specific geographic area or that have a monthly average card spend over a threshold amount.

Server computer 110 may further prioritize each pending card-linked offer to ensure that all of allocated budget for each card-linked offer is used up while also preventing or minimizing card-linked offers from going over budget. For example, a card-linked offer may have a spend budget of $10,000 and the advertiser may wish to use a combination of active and passive card-linked offers, where half of the card-linked offers for a $1.00 credit are sent out as active card-linked offers for a budget commitment of $5,000, and the other $5,000 is to be allocated to passive card-linked offers. However, much like the airline industry overbooks a specific airplane knowing that it is likely some people will cancel or simply not show up, passive card-linked offers may be sent out to more card holders than the budget would support if all of this specific card-linked offers were active. Continuing the above example, the same $1.00 offer may be sent passively to 10,000 card holders if statistically only one half of users take the necessary step(s) to turn the passive offer into an active offer (e.g., click a link to view offer). However, if say 6,000 card holders take the action to view the card-linked offer, thereby turning the card-linked offer from passive into active offers, then the budget for this card-linked offer of $5,000 is exceeded by $1,000. Here, the card-linked offer provider may have to absorb the extra budget cost or approach the advertiser to increase the advertiser's spend on this advertisement.

As shown in FIG. 2, an example card-linked offer system 200 may be a distributed or networked system having server computer 110 in communication with card holder information database 120 and flighting parameter database 130 over a network 150. A variety of card holder devices 140 may also be in communication with server computer 110. For example, card holder devices 140 may include a smartphone, a laptop computer, a tablet computer, a desktop computer and the like.

Card-linked offer system 100, 200 may be configured to provide card-linked offer scheduling as an automated process based on quantifiable inputs (e.g., flighting parameters), thereby speeding up the flighting process while eliminating or limiting human error through manual transfer of information over periods of time. The flighting of card-linked offers may be a multi-step prioritization process, where one prioritization step is based on a priority to the card- linked offer provider, such as flighting priorities that may include how much budget is left, the size of the client (e.g., national client vs. mid-level client), commissions or kickers to the card-linked offer provider, and the like. Multiple card-linked offers may be ranked according to the card-linked provider oriented priorities. An assignment engine may then reshuffle or reorder the card-linked offer priorities based on card holder information, such as card holder purchase history, card holder preferences, when or how often the card holder has received the same or similar card-linked offer, and the like. Example aspects may also include consideration of financial institution or card issuer rules and/or priorities.

Card-linked offers may be structured in various formats. For example, an insertion order (IO) is a contract with an advertiser that specifies the details of the advertising program. An IO may include the total dollar value and duration of the spend, but will not include the specific deals that will be run. A deal relates to an IO, specifying monetary terms (e.g., budget, construct) and targeting parameters. In some cases (e.g., mid-level) each IO only has one deal, but in other cases (e.g., national) an IO may have more than one deal associated with it. These deals may have different start/end dates, budgets, and constructs, or they can all be the same. Deals may be differentiated by how the deals are targeted (e.g., lapsed customer, loyal customer, new customer). A network deal is a deal specific to a specific financial institution (FI) network in which the deal is scheduled to run. Each deal may have multiple network deals associated with it, as a deal may run multiple times on multiple FI networks. Redemptions (and therefore spend, revenue, etc.) are tracked on each network deal, and then rolled up to the deal level to calculate totals and budget burn-down (e.g., how much and how fast the budget is spent). A campaign may be used to indicate any of an IO, a deal or a network deal.

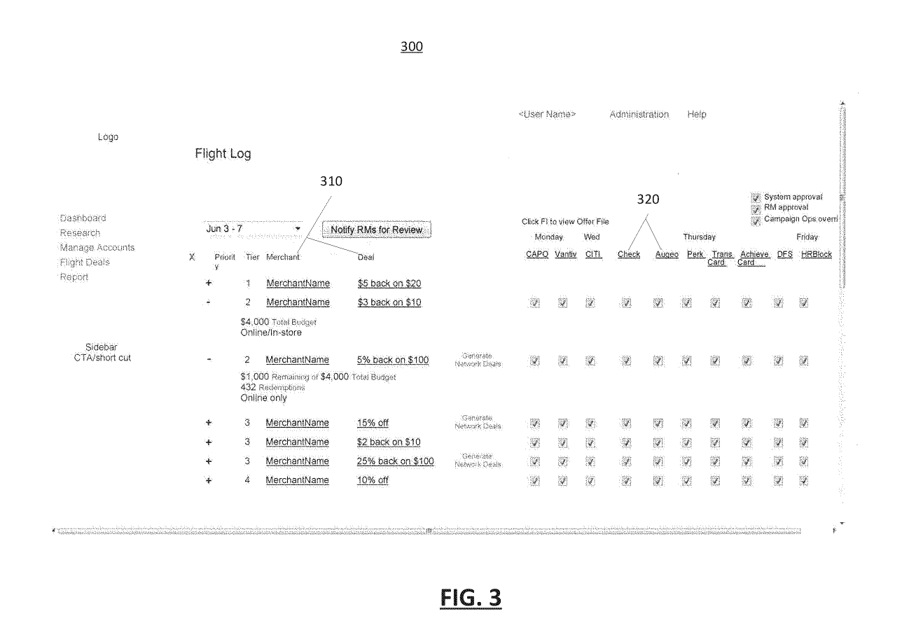

FIG. 3 illustrates an example flighting interface 300. The task of flighting card-linked offers may be performed primarily by campaign operations of a card-linked offer provider. For example, an advertiser may have a large multi-faceted campaign that includes many products and/or services to be offered in card-linked offer deals. Campaign managers or operations staff may use flighting interface 300 to manage or schedule flighting of the card-linked offer deals. For example, information may be presented in a scheduling grid 350 with a grid format having grid columns 310, where each financial institution (FI) is represented in a separate FI grid column 320 and having launch dates of associated card-linked offers listed in the FI grid columns 320. Other grid columns 310 may include the flighting priority, the tier of the advertiser, the name of the advertiser, the card-linked offer deal, and the like.

Eligibility of each card-linked offer may be considered. For example, any card-linked offer deal having a signed contract, that has or will reach its start date for the week being scheduled, and is not on the blacklist or in a grace period for a given FI may be eligible to be scheduled for flighting. Pulling in the correct and eligible offers to be scheduled each week may be dependent upon information including an advertiser blacklisting (e.g., if advertiser blacklisted, do not include in scheduling grid 350), a grace period (e.g., if card-linked offer is in a grace period for the scheduling week, do not include in scheduling grid 350), IO start date (e.g., if the IO start date is greater than the scheduling week, do not include in scheduling grid 350), IO end date (e.g., if the IO end date is less than or equal to the scheduling week, do not include in scheduling grid 350), has budget remaining, and targeting parameters (e.g., offers with the narrowest targeting parameters may be prioritized at the top of the scheduling grid 350).

Priority metrics may include the tier (e.g., tier 1-4), remaining budget divided by potential number of flights, an FI rating, approved number of card holders, description of the deal. A manual override may provide an ability to manually exclude a deal from scheduling, such as if an error is discovered or a previously unknown reason is found why the deal is ineligible. The flighting schedule may also be saved, which may trigger a notification to rules research and targeting teams with the list of the deals that are scheduled and rules research and targeting may begin. If an end date falls in the middle of a flight period, that deal may only be valid until the hard end date. The flighting schedule may also require approval by an authorized person.

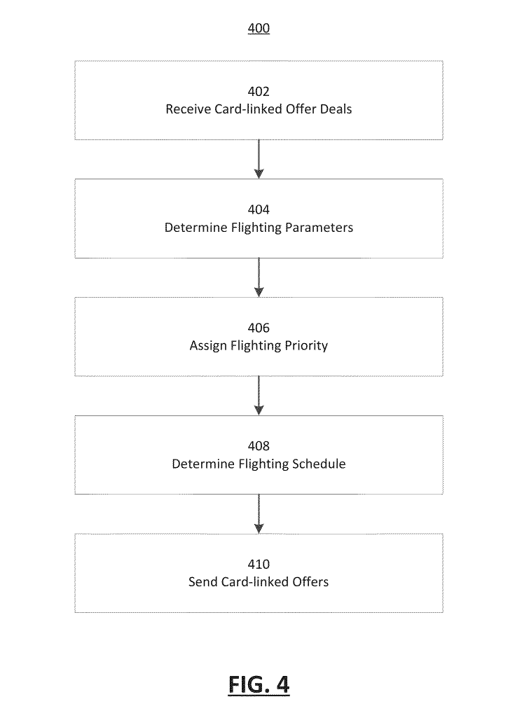

FIG. 4 illustrates an example process 400 for providing a card-linked offer. The process 400 begins at step 402 where a plurality of card-linked offer deals are received or identified. For example, each card-linked offer deal may be negotiated with or received from an advertiser wishing to provide card-linked offers to a targeted group of card holders, where the card-linked offers are to be provided by a card-linked offer provider. Each card-linked offer deal specifies at least one card-linked offer to be provided to card holders associated with one or more card issuers. One or more flighting parameters associated with the card-linked offer deal are determined at step 404. For example, FI approval, card-linked offer provider approval, advertiser information (e.g., name, industry, geography, historical card-linked offer performance), budget remaining and the like may be considered individually or in combination.

At step 406, a flighting priority is assigned to each card-linked offer deal. For example, a card-linked offer deal may be assigned a high priority if it is rated highly in multiple flighting parameters, while another card-linked offer deal may be assigned a lower priority if it is rated lower in the same flighting parameters or is rated in only a few flighting parameters. Determining a flighting schedule is provided at step 408. For example, all available or eligible card-linked offer deals may be ranked according to flighting priority and the flighting schedule may be determined automatically based on the flighting priorities. The flighting schedule may be adjusted based on manual input from an authorized user. The flighting schedule may be based on multiple flighting priorities, where each flighting priority is based associated with a different card-linked offer deal.

The process 400 ends at step 410 where the flighting schedule is executed, thereby sending each card-linked offer associated with a card-linked offer deal to a targeted group of card holders at the appropriate date/time. The flighting schedule may be executed across multiple card issuers or FIs.

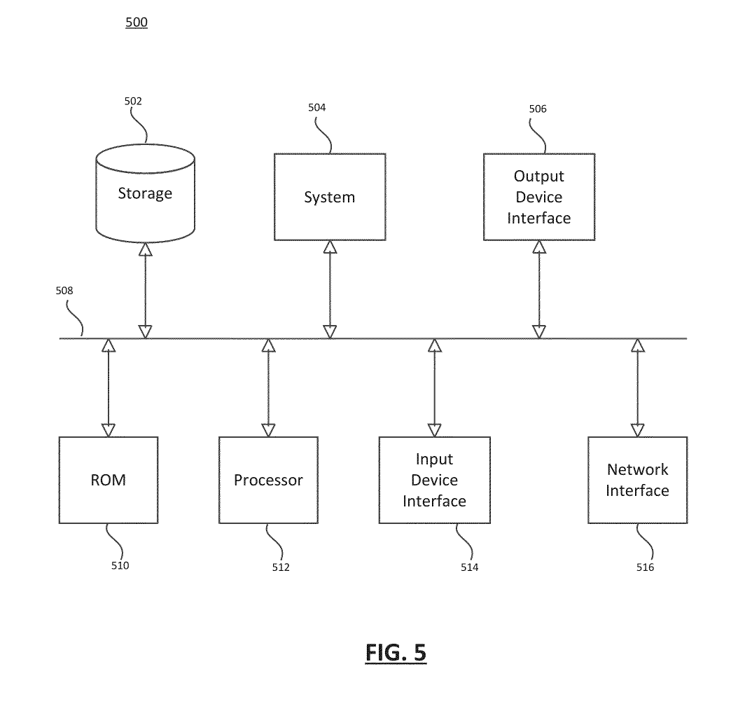

FIG. 5 conceptually illustrates an example electronic system with which some implementations of the subject technology can be implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (for example, a magnetic or optical disk and its corresponding disk drive) as permanent storage device 502.

Other implementations use a removable storage device (for example, a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, or ROM 510. For example, the various memory units include instructions for unlocking an electronic device in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, for example, liquid crystal displays (LCD). Some implementations include devices, for example, a touchscreen that functions as both input and output devices.

Further, as shown in FIG. 4, bus 508 also couples electronic system 500 to a network (not shown) through a network interface 516. In this manner, the computer can be a part of a network of computers (for example, a local area network (“LAN”), a wide area network (“WAN”), or an Intranet, or a network of networks, for example, the Internet. Any or all components of electronic system 500 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., an LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims.

What is claimed is:

1. A computer implemented method for providing a card-linked offer, the method comprising:
receiving, by one or more processors, a card-linked offer deal, wherein the card-linked offer deal specifies at least one card-linked offer to be provided to card holders associated with at least one card issuer;
determining, by one or more processors, one or more flighting parameters associated with the card-linked offer deal;
assigning, by one or more processors, a flighting priority to the card-linked offer deal based on the flighting parameters;
determining, by one or more processors, a flighting schedule of the card-linked offer deal based on the flighting priority assigned to the card-linked offer deal; and
executing, by one or more processors, the flighting schedule to send the at least one card-linked offer to targeted card holders.

2. The computer implemented method of claim 1, wherein the one or more flighting parameters include card issuer approval.

3. The computer implemented method of claim 1, wherein the one or more flighting parameters include flighting provider approval.

4. The computer implemented method of claim 1, wherein the one or more flighting parameters include an advertiser's identity.

5. The computer implemented method of claim 1, wherein the one or more flighting parameters include an advertiser's industry.

6. The computer implemented method of claim 1, wherein the one or more flighting parameters include an advertiser's geography.

7. The computer implemented method of claim 1, wherein the one or more flighting parameters includes an advertiser's historical card-linked offer performance.

8. The computer implemented method of claim 1, wherein the one or more flighting parameters includes card holder activity with an advertiser prior to any card-linked offer associated with the card holder.

9. The computer implemented method of claim 1, wherein the one or more flighting parameters includes a number of total possible recipients.

10. The computer implemented method of claim 1, wherein the one or more flighting parameters includes a recipient's perceived value of the card-linked offer deal.

11. The computer implemented method of claim 1, wherein the one or more flighting parameters includes a predicted number of redemptions for a specified flighting period.

12. The computer implemented method of claim 1, wherein the one or more flighting parameters includes a remaining budget.

13. The computer implemented method of claim 1, wherein the one or more flighting parameters includes a flighting provider commission.

14. The computer implemented method of claim 1, wherein the one or more flighting parameters includes a paid placement.

15. The computer implemented method of claim 1, wherein the one or more flighting parameters includes forms of payment accepted.

16. The computer implemented method of claim 1, wherein the flighting schedule is based on a plurality of flighting priorities, wherein each flighting priority is associated with a different card-linked offer deal.

17. The computer implemented method of claim 1, wherein the flighting schedule is executed across a plurality of card issuers.

18. A system for providing a card-linked offer, the system comprising:
a server computer for determining and scheduling flighting of a card-linked offer deal;
a first database in communication with the server computer, the first database comprising user profile information of a plurality of card holders; and
a second database in communication with the server computer, the second database comprising one or more flighting parameters associated with the card-linked offer deal,
wherein the server computer assigns a flighting priority to the card-linked offer deal,
wherein the server computer determines a flighting schedule for the card-link offer deal based on the assigned flighting priority,
wherein the server computer determines a target group of the plurality of card holders, and
wherein the server computer sends a communication of a card-linked offer to the target group of card holders based on the flighting schedule.

19. A non-transitory machine-readable storage medium comprising machine readable instructions for causing a processor to execute a method for providing a card-linked offer, the method comprising:
receiving, by one or more processors, a card-linked offer deal, wherein the card-linked offer deal specifies at least one card-linked offer to be provided to card holders associated with at least one card issuer;
determining, by one or more processors, one or more flighting parameters associated with the card-linked offer deal;
assigning, by one or more processors, a flighting priority to the card-linked offer deal based on the flighting parameters;
determining, by one or more processors, a flighting schedule of the card-linked offer deal based on the flighting priority assigned to the card-linked offer deal; and
executing, by one or more processors, the flighting schedule to provide the at least one card-linked offer to targeted card holders.
